(19) United States
(12) Patent Application Publication
(10) Pub. No.: US 2007/0039691 A1
(43) Pub. Date: Feb. 22, 2007

(54) Methods for producing wood inlays and articles produced thereby

(76) Inventor: Christopher P. Mroz, Gig Harbor, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/507,684

(22) Filed: Aug. 21, 2006

Related U.S. Application Data
(60) Provisional application No. 60/709,642, filed on Aug. 19, 2005.

(51) Int. Cl. B32B 37/00; B32B 37/12; C09J 5/00

(52) U.S. Cl. 156/293; 156/305

(57) ABSTRACT

The invention is directed to methods for producing wood inlays and articles produced thereby.

### BACKGROUND OF THE INVENTION

1. Description of the Prior Art

Inlays are commonly created using the techniques of intarsia, parquetry and marquetry. These techniques are generally time consuming in that the inlay must be exactly formed to fit within the recess of the base material; these techniques do not lend themselves to conventional mass production, and are more suited to straight, rather than curving segments. Curved inlays provide an extra challenge in that the curved portions must be precisely cut from solid wood or veneers to match the complementary patterns formed in the base material. Thus, the inlay arts are restricted to niche markets where the extra cost is warranted by a commitment to fashion or desire that transcends the high cost of limited production.

### SUMMARY OF THE INVENTION

The invention is directed to methods for creating inlay articles utilizing plasticized wood as the inlay material and articles produced thereby. A method for creating an inlay article comprises forming a recess in a base material; filling at least a portion of the recess with plasticized wood; and preferably, but not necessarily, causing the plasticized wood to recover a significant portion of its original structural rigidity. Unlike conventional inlay, intarsia and marquetry wherein the wood inlays have their structural rigidity preserved prior to insertion within the base material recess, the inlay material of the invention utilized plasticized wood. The advantage of its use becomes most apparent when creating curvilinear inlays having a constant sectional width: because of the plasticized wood's general lack of structural rigidity prior to curing or drying, one need only be concerned about the recess and inlay's dimensions independent of their geometry in such applications. This makes creation of curved inlays fundamentally easy when compared with the traditional task of duplicating the recess geometry in the inlay material in addition to its dimensions in order to achieve a close fit. It may also supplement or replace marquetry that requires all pieces to be cut independently of each other, then fit together to form the desired solid or end product, rather than by simply modifying the base material as in this invention.

Articles produced by the foregoing method are characterized as visually similar to conventional inlay, intarsia and marquetry, but comprise at least one inlay of plasticized wood in a base material, which is not necessarily wood, as will be described below.

With respect to the method and articles produced thereby, the base material in which a recess is formed need only be of sufficient rigidity to maintain the recess profile during formation and introduction of the plasticized wood. With concrete, the compressed wood is typically introduced before the concrete is poured. In this situation, the concrete is poured around the inlay, which is first fixed to the form material (mold). Thus, candidate base materials comprise the following non-exhaustive list: woods (natural or engineered), thermoforming plastics, thermosetting plastics, minerals (native such as stones or composites), metals, compositions such as ceramics and concrete, tiles, and equivalent structures. The formation of the recess can take place at the time of base creation (such as by casting or assembly such as in tile mosaics), by post base creation through material removal (such as by routing, machining, etc.), or by other suitable means. Candidate plasticized woods include all forms of structural cellulose and particularly include wood derived from deciduous species. In a preferred series of embodiments, the plasticized wood comprises compressed wood, which is described in more detail below.

The recess formed in the base material may have any cross sectional geometry; plasticized wood is inherently pseudo-viscous under certain conditions prior to recovery of its structural rigidity, and has the ability to assume a wide variety of cross sectional profiles when subject to elevated temperature and compression (if needed). Moreover, the recess may have perimeter boundaries characterized as rectilinear, curvilinear or combinations thereof. In addition, the recess may be elongate such as in a groove, or may occupy a dimensionally large area. As used herein, a recess comprises any void or relief formed in the base material.

The invention relies upon the use of plasticized wood, which can be derived through chemical and/or mechanical treatment of wood, and enhanced by proper selection of tree species and/or genetic modification of tree species. While use of plasticized wood derived from chemical treatment is considered within the scope of the invention, mechanically treated wood is the preferable source of plasticized wood for the inlay material. Mechanically treated, or compressed wood, and related methods for creating the same are known in the art and per se do not form the subject matter of the invention. Nevertheless, prior U.S. Pat. No. 5,190,088 issued on 2 Mar. 1993, which is incorporated herein by reference, discloses preferred wood compression techniques, and is presently considered the best mode for obtaining compressed wood for use with the invention.

While most applications of the invention will parallel those known for conventional inlay, intarsia and marquetry, use of plasticized wood also permits the inclusion of relief forms. If compressed wood is used, it is further possible to “emboss” the compressed wood with three dimensional designs or “cut” the compressed wood though stamping. In this manner, rapid creation of inlayed designs can be created, preserved for future use, and incorporated into appropriately shaped recesses. Thus, the inlay material of the invention is not limited to planar exposed surfaces, but also includes relief forms.

Once the plasticized wood has been introduced into the recess, conventional means can be employed to secure it in the recess, and include the use of adhesives, mechanical fasteners and simple friction fit. Moreover, and unlike traditional inlay techniques, intarsia or marquetry, a lower perimeter portion of the recess can be slightly enlarged to provide an anchor location for the plasticized wood inlay. Because of the plasticized wood's pseudo-viscosity under certain conditions, it can be compressively inserted, preferably under elevated temperature conditions, into a recess having an outwardly extending flange portion formed in a lower perimeter portion of the recess. The result of this compressive insertion is the migration of the plasticized wood into at least a part of this flange portion. Upon recovery of at least part of its structural rigidity, the inlay is securely associated with the base material without the use of adhesives, mechanical fasteners or other securing means.

Recovery of at least part of the plasticized wood's structural rigidity can be accomplished by removal of the plasticizing agent (primarily in the case of chemically treated wood) such as through the use of solvents or evaporation, or in the case of mechanically treated wood (e.g., compressed wood), through reduction of the moisture content of the wood. Reduction in the moisture content of the compressed wood can be accomplished by simple exposure to the environment as long as a moisture gradient favors the environment, or by accelerated means such as heating through exposure to elevated temperatures or radiation.

The invention will find applications in both the decorative and structural field. In the fields of decorative applications, the invention's utility parallels those applications that traditionally utilize conventional inlay, intarsia, parquetry or marquetry, with particular appeal to applications involving the use of routers or similar recess forming tools where the recess width is relatively constant. By establishing recesses of this nature, a single length of plasticized wood having a generally constant width and depth can be bent to match tight radii and all but the most complicated geometric shapes. Thus, possible applications include flooring such as borders and medallions; baseboards; casements; moldings; furniture; beams; posts; logs; stair treads; handrails; fireplace surrounds and mantles; trivets; cutting boards, paneling, ceiling decorations, counter tops, and inlay blocks that may subsequently be cut into veneers.

It should also be noted that intersecting inlays are easily created through practice of the methods disclosed herein. Intersecting inlays are created by establishing a first recess in a base material, introducing and securing a first inlay in the first recess, preferably sanding the first inlay flush with the base material, establishing a second recess in the base material wherein the second recess includes at least one intersection with the first recess, and introducing and securing a second inlay.

In the fields of structural applications, the invention's utility parallels those applications that traditionally utilize formed wood. By way of example, a structural application may be exploited by using curved inlays in solid wood like logs or beams that are otherwise subject to checking or cracking. The curved inlay resists the wood's tendency to shrink, then crack, as it dries out by stopping or disrupting large cracks from forming. More numerous smaller cracks may form, and allow the moisture to escape over a larger surface area. This provides an advantage, for example, in timber-framed and log house construction as well as in other applications where it may be disadvantageous to allow solid wood to crack or check as it dries. The inlay may also be added to a circumferentially oriented recess or groove around a round object like a log or round post, thereby providing an elegant structural replacement for a hoop or other similar recessed structure. Moreover, in such structural applications, it is not necessary to recess the base material to form an inlay: surface mounted hoops, for example, can be used with equal effectiveness when compared to recessed hoops and beneficially reduce overall costs through decreased labor. In addition, the plasticized wood undergoes measurable shrinkage during a curing phase, which would operate to further radially constrict an object disposed within the hoop.

### BRIEF DESCRIPTION OF THE DRAWINGS

FIG. 1 is a perspective mosaic of 16 tiles, each having an inlay pattern formed therein that lends itself to an integrated, repeating pattern;

FIG. 2A is a perspective view of a single tile of the mosaic shown in FIG. 1;

FIG. 2B is a perspective view showing a first step in forming the tile of FIG. 2A;

FIG. 2C is a perspective view showing a second step in forming the tile of FIG. 2A;

FIG. 2D is a perspective view showing a third step in forming the tile of FIG. 2A;

FIG. 2E is a perspective view showing a fourth step in forming the tile of FIG. 2A;

FIG. 2F is a perspective view showing a fifth step in forming the tile of FIG. 2A;

FIG. 2G is a perspective view showing a sixth and final step in forming the tile of FIG. 2A;

FIG. 3A is a perspective view of a board having a continuous serpentine inlay formed therein;

FIG. 3B is a perspective view showing a first step in forming the board of FIG. 3A;

FIG. 3C is a perspective view showing a second step in forming the board of FIG. 3A;

FIG. 3D is a perspective view showing a third step in forming the board of FIG. 3A;

FIG. 3E is a perspective view showing a fourth and final step in forming the board of FIG. 3A;

FIG. 4 is an elevation view in cross section of FIG. 2A taken substantially along the line 4-4;

FIG. 5 is an elevation view in cross section of a channel recess having a flanged or enlarged lower portion to aid in the retention of an introduced inlay;

FIG. 6 an elevation view in cross section of a channel recess having a flanged or enlarged upper portion to aid in the insertion of an introduced inlay;

FIG. 7 is a perspective view of a deep board including a deep inlay having a plurality of cuts made to produce identical thin boards having “through-lays”; and

FIG. 8 is a perspective view of a wood column having four helical inlays, demonstrating the flexibility of inlay application.

The following discussion is presented to enable a person skilled in the art to make and use the invention. Various modifications to the preferred embodiment will be readily apparent to those skilled in the art, and the generic principles herein may be applied to other embodiments and applications without departing from the spirit and scope of the present invention as defined by the appended claims. Thus, the present invention is not intended to be limited to the embodiment shown, but is to be accorded the widest scope consistent with the principles and features disclosed herein. Also note that the grain patterns shown in the several Figures is for illustration purposes only, and is not intended to restrict or suggest that the inlay material must be formed or used as such.

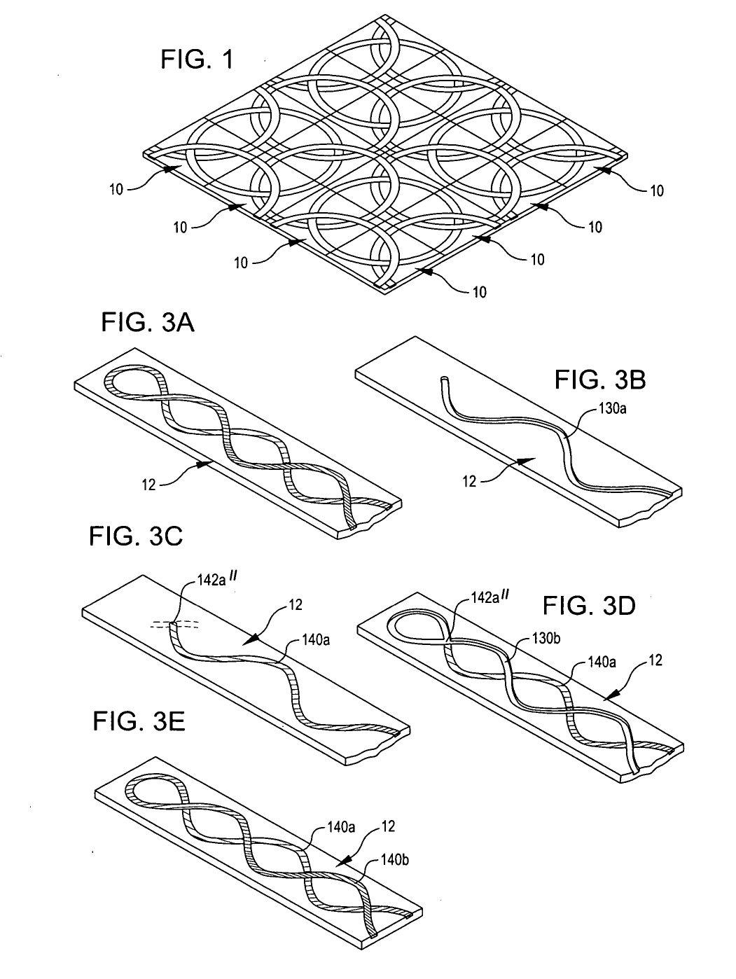

Turning then to the several Figures, wherein like numbers indicate like parts, and more particularly to FIGS. 1-3, which are example articles of manufacture using the methods of the invention are shown. In particular, FIG. 1 illustrates a first embodiment where a highly ornate inlay pattern has been created in 16 abutting tiles 10 to form a pattern of intersecting circles. As shown, tiles 10 comprise base material 20, which in the illustrated embodiment is 12″ by 12″ by ¾″ milled hardwood, and inlay elements 40 (the inlay elements are generally referred to as “40” but where the description would benefit from differentiation, each element will be appended with a suffix, such as “a”, “b”, “c”, etc.). In the illustrated embodiment, inlay 40 is compressed Ash wood. For additional information regarding compressed wood, see U.S. Pat. No. 5,190,088 issued on 2 Mar. 1993, which is incorporated herein by reference.

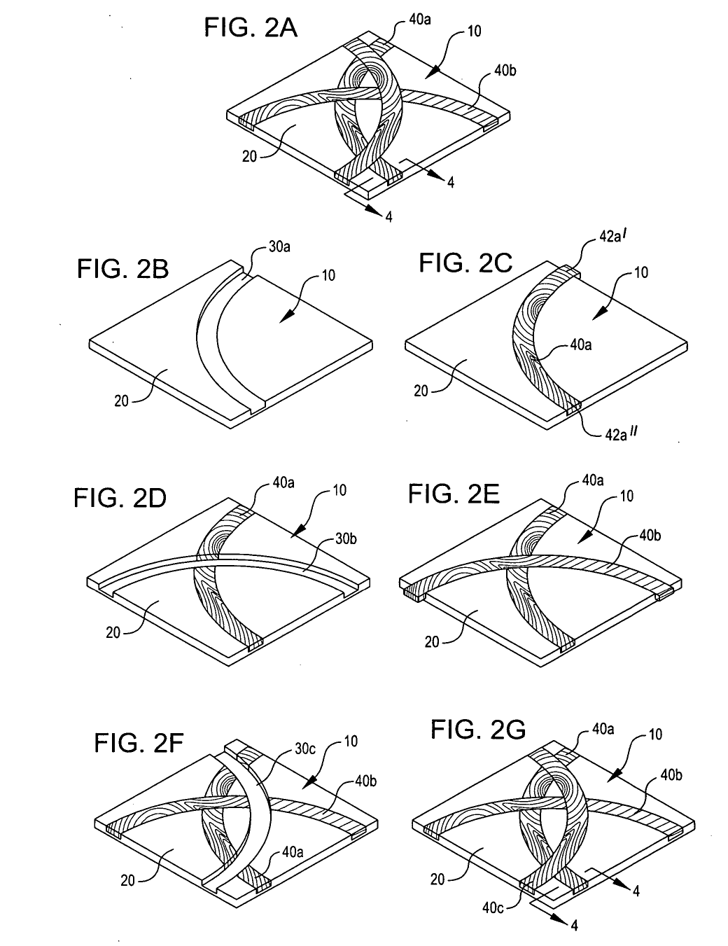

The creation of tiles 10 shown in FIG. 1 is best demonstrated in FIGS. 2A-2G. Each tile 10 comprises base material 20, and as shown therein, first channel recess 30a is formed therein, such as by a router, and is nominally 5/16″ deep. Once so formed, inlay 40a is introduced into channel recess 30a, and ends 42a′ and 42a″ are trimmed to length as shown with respect to end 42a″ (end 42a′ being shown prior to trimming). Inlay 40a is preferably adhered to base material 20 such as by a waterproof glue, but inlay 40a may be friction fit and/or rely upon the use of a flared channel recess such as channel recess 30′ shown in FIG. 6. Inlay 40a in the illustrated method is also sized to snuggly fit within channel recess 30a; the height of inlay 40a is approximately equal to, or slightly greater than, the maximum sectional depth of channel recess 30a. Thus, minor to moderate compression of inlay 40a during insertion into channel recess 30a will result in a fairly finished product, needing only light sanding or planing. The light sanding or planing may be done at the conclusion of this first step, or may be done at any other juncture during the formation process.

Once inlay 40a has been satisfactorily introduced into channel recess 30a, second channel recess 30b is created as is shown in FIG. 2C. As with inlay 40a, inlay 40b is introduced into channel recess 30b, and ends 42b′ and 42b″ are trimmed to length as shown in FIG. 2D. Also as was the case with inlay 40a, inlay 40b can be adhered to base material 20. In all other material respects, inlay 40b is similar to inlay 40a.

FIG. 2E illustrates the formation of third channel recess 30c and the introduction of inlay 40c in the same manner as with inlay 40a and inlay 40b. Once completed, tile 10 may be sanded, planed, or otherwise finished. The skilled artisan will appreciate that deciding what order to introduce the inlay pieces is influenced by the design, the wood species being used, and which part of the inlay is to be emphasized. If several wood species are used, like ash, cherry, and walnut, the color of the wood and contrast with the background wood is also considered. However, it has been found that the sequential formation of channel recesses and inlay introductions described herein results in an efficient and visually appealing article of manufacture that does not require “pre-cutting” of the inlays to conform to the lineal value of the channel recess. Moreover, the ability to use compressed wood as the inlay material eliminates the need to pre-form the inlay, thereby significantly reducing manufacturing costs and construction time.

Turning then to FIG. 3A, a “continuous” type pattern is shown. Here, an approach similar to the formation of tile 10 is taken concerning board 12. FIG. 3B shows the creation of first channel recess 130a while FIG. 3C shows the introduction of first inlay 140a. Second channel recess 130b is formed in board 12 as best shown in FIG. 3D. Note that end 142a″ is inherently trimmed during formation of second channel recess 130b, leaving a clean butt joint with second inlay 140b as demonstrated in FIG. 3E. Again, it should also be emphasized that by engaging in this sequential cut-and-cover method, the incidences of inlay trimming are drastically reduced in that subsequent cutting of previously inlayed wood inherently dimensions such inlay to terminate adjacent to a new inlay.

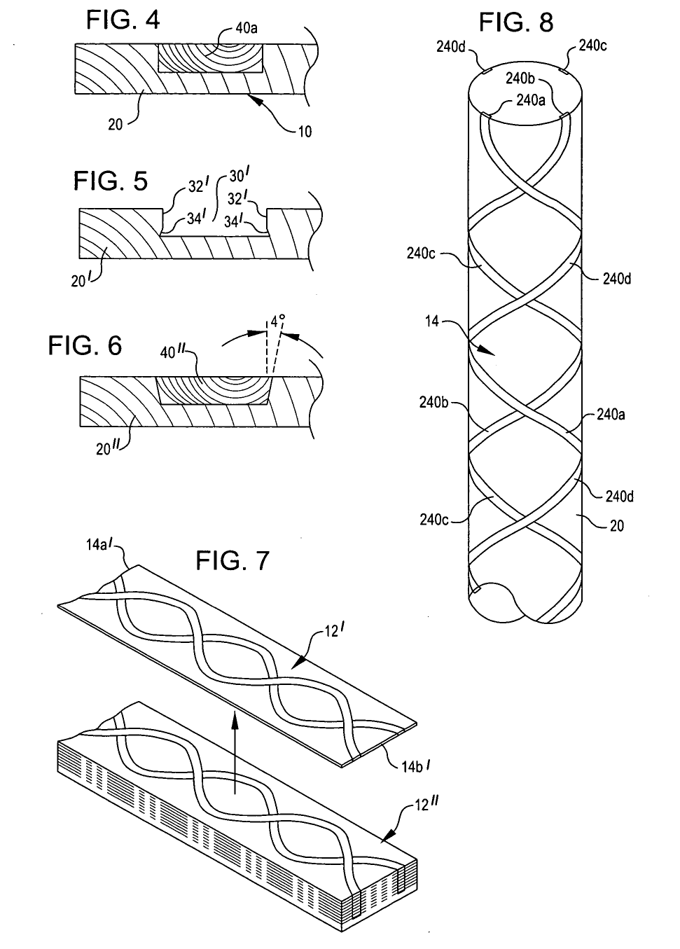

FIGS. 4-6 illustrate various cross sectional profiles of the channel recess. FIG. 4 is a partial cross section elevation of tile 10 in FIG. 2G. Here, both recess channel 30a and inlay 40a have sides that are orthogonal to the base. To provide a potentially adhesive-free linkage between the inlay and the recess channel, it is possible to form a flared base, as shown in FIG. 5. Here, channel recess 30′ has a base portion 34′ that is wider than an upper portion 32′, thereby creating an interference fit should the inlay be urged towards upper portion 32′. The inlay to be introduced into channel recess 30′ may be cut to fit the geometry of recess 30′ wherein the base portions are compressed during introduction and recover their shape after full insertion, or the plasticity of the compressed wood can be relied upon and additional base material can be extruded under pressure to fill the voids. FIG. 6 illustrates a reverse approach to that of FIG. 5 wherein upper portion 32″ is wider than base portion 34″. In the illustrated embodiment, the side walls of the channel recess diverge from the normal by about 4°.

Several novel possibilities present themselves that would otherwise be difficult or impossible to achieve without practicing of the instant invention. In a first case, which is illustrated in FIG. 7, a very deep channel recess is created in a suitable base material such as board 12″. Compressed wood 40 is introduced therein as an inlay, and caused to permanently bond thereto. By sectioning off a plurality of boards 12′, which visually resemble boards 12 of FIGS. 3A and 3E but wherein inlay 40 extends from one surface to the opposing surface, a rapid means for producing a plurality of identical boards 12′ can be practiced. This approach is particularly advantageous when creating boarders or trim that require several boards to be placed in end-to-end relationship. By ensuring that end 14a′ and end 14b′ are complementary, a continuous visual impression can be established when end 14a′ of one board 12′ is placed adjacent to end 14b′ of another board 12′.

In a second case, circumferential channel recesses can be formed in a circular or cylindrical (as well as any other geometric form in cross section) base material, and a suitable inlay introduced therein, such as is shown in FIG. 8. Here, wood column 14 forms base material 20, and four (4) helical channel recesses are formed therein, as shown. Inlays 240a-d are introduced in the corresponding recesses and bonded to column 14 as previously described with respect to other embodiments disclosed herein. These bonded inlays substantially prevent checking and other deleterious effects of drying in addition to adding a novel visual impression. It should be noted that each inlay can be and is preferably continuous. The fact that the inlay can be and preferably is continuous significantly adds to its ability to resist radial expansion or contraction, which leads to the previously mentioned checking and cracking, when the subject inlays are not employed. To the best of the inventor's knowledge, no other wood or cellulose-based material is capable of such performance, and no other material can be applied using the methods disclosed herein.

What is claimed:

1. A method for creating an article having an inlay element in a base material comprising:
forming a recess in a base material wherein the recess has a height and a width at any location along a length thereof; and
filling at least a portion of the recess with plasticized wood to create an inlay element.

2. The method of claim 1 wherein the base material is wood.

3. The method of claim 1 wherein the base material is one of thermoforming plastic, thermosetting plastic, mineral, metal, ceramic, concrete, tile, or any combination of the above.

4. The method of claim 1 wherein the recess is created during the formation of the base material.

5. The method of claim 1 wherein the recess is created after formation of the base material.

6. The method of claim 1 wherein the recess comprises a rectilinear section.

7. The method of claim 1 wherein the recess comprises a curvilinear section.

8. The method of claim 1 further comprising a second recess that intersects with the first recess.

9. The method of claim 1 wherein the recess comprises a flared or flanged base portion.

10. The method of claim 1 wherein the recess has a variable width along its length.

11. The method of claim 1 wherein the plasticized wood has a height generally equal to the depth of the recess at one location along the length of the recess.

12. The method of claim 1 wherein the plasticized wood has a height generally greater than the depth of the recess at one location along the length of the recess.

13. The method of claim 1 wherein the plasticized wood has a height generally less than the depth of the recess at one location along the length of the recess.

14. The method of claim 1 wherein the plasticized wood has an upper surface and the upper surface is generally planar.

15. The method of claim 1 wherein the plasticized wood has an upper surface and the upper surface comprises a tactilely perceptible pattern.

16. The method of claim 15 wherein the pattern is repeating.

17. The method of claim 1 wherein the plasticized wood has an upper surface and the upper surface comprises a visually perceptible pattern.

18. The method of claim 17 wherein the pattern is repeating.

19. The method of claim 1 further comprising establishing an adhesive layer between the base material and the plasticized wood.
